(19) United States
(12) Patent Application Publication
(10) Pub. No.: US 2024/0179284 A1
(43) Pub. Date: May 30, 2024

(54) DUAL-PATH DISPARITY SENSOR

(71) Applicant: Meta Platforms Technologies, LLC, Menlo Park, CA (US)

(72) Inventor: Michiel Koen CALLENS, Mountain View, CA (US)

(21) Appl. No.: 18/519,968

(22) Filed: Nov. 27, 2023

Related U.S. Application Data
(60) Provisional application No. 63/385,031, filed on Nov. 27, 2022.

(51) Int. Cl. H04N 9/31; G02B 6/34; G02B 27/00; G02B 27/01

(52) U.S. Cl. CPC H04N 9/3194; G02B 6/34; G02B 27/0093; G02B 27/0172; G02B 2027/014

(57) ABSTRACT

A waveguide display system includes a waveguide transparent to visible light, a projector configured to project disparity test light onto the waveguide, an input coupler configured to couple the disparity test light into the waveguide, and a set of gratings on the waveguide. The set of gratings is configured to guide the disparity test light to propagate along two different paths in the waveguide, and couple the disparity test light propagating along the two different paths out of the waveguide at a peripheral region of the waveguide. The set of gratings includes two disparity gratings having different grating vectors or a two-dimensional grating having two different grating vectors. The disparity test light on a longer primary path includes the full color spectrum of the disparity test light, while the disparity test light on a shorter secondary path includes only disparity test light having shorter wavelengths.

### CROSS-REFERENCE TO RELATED APPLICATION

This application claims the benefit of and priority to U.S. Provisional Application No. 63/385,031, filed Nov. 27, 2022, entitled “DUAL-PATH DISPARITY SENSOR,” which is herein incorporated by reference in its entirety for all purposes.

### BACKGROUND

An artificial reality system, such as a head-mounted display (HMD) or heads-up display (HUD) system, generally includes a near-eye display (e.g., in the form of a headset or a pair of glasses) configured to present content to a user via an electronic or optic display within, for example, about 12-20 mm in front of the user's eyes. The near-eye display may display virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)), and the surrounding environment by, for example, seeing through transparent display glasses or lenses (often referred to as optical see-through).

One example of an optical see-through AR system may use a waveguide-based optical display, where light of projected images may be coupled into a waveguide (e.g., a transparent substrate), propagate within the waveguide, and be coupled out of the waveguide at different locations. In some implementations, the light of the projected images may be coupled into or out of the waveguide using diffractive optical elements, such as surface-relief gratings or volume Bragg gratings. Light from the surrounding environment may pass through a see-through region of the waveguide and reach the user's eyes as well.

### SUMMARY

This disclosure relates generally to near-eye display systems. More specifically, techniques disclosed herein relates to waveguide-based near-eye display systems including disparity gratings for detecting boresight errors between the left image and the right image in a including devices, components, systems, modules, subsystems, and the like.

According to certain embodiments, a waveguide display system may include a waveguide, an input coupler on the waveguide and configured to couple disparity test light into the waveguide, a first disparity grating on a peripheral region of the waveguide, a second disparity grating on the peripheral region of the waveguide; and one or more output gratings on the waveguide. The one or more output gratings may be configured to direct a first portion of the disparity test light coupled into the waveguide along a first path to the first disparity grating, and direct a second portion of the disparity test light coupled into the waveguide along a second path to the second disparity grating. The first disparity grating may be configured to couple the first portion of the disparity test light out of the waveguide, and the second disparity grating may be configured to couple the second portion of the disparity test light out of the waveguide.

In some embodiments of the waveguide display system, the second portion of the disparity test light may include a portion of blue light of the disparity test light. The second portion of the disparity test light may have a larger incident angle on surfaces of the waveguide than the first portion of the disparity test light. In some embodiments, the first disparity grating and the second disparity grating may have different grating vectors, and may be on opposing surfaces of the waveguide or different regions of a surface of the waveguide. In some embodiments, the first disparity grating and the second disparity grating may have different grating vectors, and may be on a same region or overlapped regions of a surface of the waveguide to form a two-dimensional grating.

According to certain embodiments, a near-eye display system may include a waveguide transparent to visible light, a projector configured to project disparity test light onto the waveguide, an input coupler configured to couple the disparity test light into the waveguide, and a set of gratings on the waveguide. The set of gratings may be configured to guide the disparity test light to propagate along two different paths in the waveguide, and couple the disparity test light propagating along the two different paths out of the waveguide at a peripheral region of the waveguide.

In some embodiments of the near-eye display system, the set of gratings may include two disparity gratings, each disparity grating of the two disparity gratings configured to couple the disparity test light propagating along a respective path of the two different paths out of the waveguide. In some embodiments, the two disparity gratings may be characterized by different grating vectors, and may be on opposing surfaces of the waveguide or different regions of a surface of the waveguide. In some embodiments, the set of gratings includes a two-dimensional disparity grating characterized by two different grating vectors. In some embodiments, the disparity test light propagating along a first path of the two different paths includes only blue light. In some embodiments, the disparity test light propagating along a first path of the two different paths may have a larger incident angle on surfaces of the waveguide than the disparity test light propagating along a second path of the two different paths.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display (HMD) device for implementing some of the examples disclosed herein.

FIG. 3 is a perspective view of an example of a near-eye display in the form of a pair of glasses for implementing some of the examples disclosed herein.

FIG. 4 is a cross-sectional view of an example of a near-eye display according to certain embodiments.

FIG. 5 illustrates an example of an optical see-through augmented reality system including a waveguide display according to certain embodiments.

FIG. 6 illustrates an example of an optical see-through augmented reality system including a waveguide display for exit pupil expansion according to certain embodiments.

FIG. 7A illustrates an example of an optical see-through augmented reality system including a waveguide display and surface-relief gratings for exit pupil expansion according to certain embodiments.

FIG. 7B illustrates an example of an eyebox including a two-dimensional array of replicated exit pupils.

FIG. 7C is a perspective view of an example of a waveguide display with grating couplers for exit pupil expansion according to certain embodiments.

FIG. 8A illustrates an example of a waveguide display including a disparity sensor.

FIG. 8B illustrates an example of a near-eye display including a waveguide for coupling disparity test light from two pupil-replicating waveguides to a common photodetector array for binocular disparity sensing.

FIG. 9A illustrates an example of a waveguide display including one or more disparity gratings.

FIG. 9B illustrates the path of disparity test light in the waveguide display of FIG. 9A.

FIG. 10 illustrates an example of a waveguide display including one or more disparity gratings according to certain embodiments.

FIGS. 11A-11C illustrate examples of wave vectors of disparity test light and display light of different colors guided by the waveguide display of FIG. 10 according to certain embodiments.

FIG. 12A illustrates an example of a waveguide display including one or more disparity gratings according to certain embodiments.

FIG. 12B illustrates examples of the paths of disparity test light in the waveguide display of FIG. 12A according to certain embodiments.

FIG. 13A illustrates an example of a pair of disparity gratings in a waveguide display.

FIG. 13B illustrates an example of a pair of disparity gratings in a waveguide display according to certain embodiments.

FIG. 13C illustrates examples of wave vectors of the disparity test light guided by a waveguide display that includes the pair of disparity gratings of FIG. 13B according to certain embodiments.

FIGS. 14A-14C illustrate examples of end-to-end efficiencies of disparity test light of different colors in a waveguide display that includes one or more disparity gratings having the same grating vector.

FIGS. 14D-14F illustrate examples of end-to-end efficiencies of disparity test light of different colors in a waveguide display that includes one or more disparity gratings having different grating vectors according to certain embodiments.

FIG. 15 is a simplified block diagram of an electronic system of an example of a near-eye display for implementing some of the examples disclosed herein.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

This disclosure relates generally to near-eye display systems. More specifically, techniques disclosed herein relates to waveguide-based near-eye display systems including disparity gratings for detecting boresight errors between the left image and the right image in a including devices, components, systems, modules, subsystems, and the like.

In some near-eye display systems, waveguide displays may be used to present images to users. A waveguide display may include, for each eye of a user's eyes, a light source, a waveguide, and couplers formed on or coupled to the waveguide. The light source may include one or more projectors for projecting two-dimensional color images, and may be placed at a peripheral region of the waveguide display such that it may not block the field of view of the user's eyes. The couplers may include one or more input couplers configured to couple display light into the waveguide such that the display light may propagate within the waveguide through total internal reflection. The waveguide may be transparent to visible light, and may guide the display light to propagate within the waveguide and also allow ambient light to pass through. One or more output couplers may be used to couple the display light out of the waveguide at multiple locations towards an eyebox of the near-eye display system.

Misalignments (e.g., relative tip, tilt, and rotation) between the waveguide and the light source (e.g., including a display panel and the projector) or relative movement of an assembly that includes a waveguide and the light source for an eye with respect to another assembly for the other eye may cause the display images presented to the left eye and the right eye of the user to be different from the desired two-dimensional (2D) display images that show objects according to binocular disparity such that the user's brain can extract proper depth information from the two 2D images captured by the two eyes through stereopsis. Therefore, the user may see two images of a same object and other undesired optical artifacts, such as illumination and/or color mismatch or non-uniformity, which may degrade the user experience of using the near-eye display system.

In some implementations, to reduce or otherwise mitigate the undesired optical artifacts caused by the misalignment or relative movement described above, a disparity grating (on one side or both sides of the waveguide) may be used on the nasal side of the waveguide for each eye to couple some disparity test light from the light source out of the waveguide at the nasal side of the waveguide. A disparity sensor may detect the light pattern of the disparity test light from each of the two waveguides, to determine boresight errors between the left image and the right image in the binocular near-eye display system, such that the projector(s) and/or the images generated by the display panel (e.g., a liquid crystal display panel, an organic light-emitting diode display, or a light-emitting diode display) may be adjusted to compensate for the misalignment between the waveguide and light source in an assembly of a binocular display system and/or relative movement between the two assemblies of the binocular display system.

However, it can be challenging to couple sufficiently high disparity test light signal at the nasal side of the waveguide to a disparity sensor for fast and accurate detection by the disparity sensor, in particular, for light with shorter wavelengths. For example, in some waveguide display systems, the orientation (e.g., the clocking angle) and the period of a disparity grating may match the grating of an output coupler (referred to as an output grating) for display light, and the disparity test light signal (e.g., having a certain image pattern) may follow the same path as the display light. Therefore, a large portion of the disparity test light signal may be coupled out of the waveguide by the output grating before the disparity test light signal could reach the disparity grating. As such, the intensity of the disparity test light signal that may reach the disparity grating and be coupled out of the waveguide to the disparity sensor by the disparity grating may be very low. In particular, in a single-layer waveguide design (where red light, green light, and blue light propagate in the same waveguide), the blue light (or other light having a shorter wavelength and thus a smaller diffraction angle) may interact with the waveguide and the output gratings more times and may travel a much longer distance on the propagation path in the waveguide than the red light (or other light having a longer wavelength). As such, the intensity of the blue light coupled out of the waveguide by the disparity grating may be too low and may not be sufficient for accurate detection by the disparity sensor.

In a single-layer waveguide design (e.g., a waveguide including a single SiC substrate or another material with a high refractive index and thus can guide light in a large field of view), it can be very challenging to optimize the output grating and the disparity grating for co-optimization of the efficiency of coupling display light to the eyebox and the efficiency of coupling disparity test light signal to the disparity sensor. In particular, in a single-layer waveguide using existing design, the co-optimization may not be able to achieve a sufficiently high efficiency (e.g., with the end-to-end efficiency greater than about 0.00025%) for the blue channel of the disparity test light.

According to certain embodiments, the signal level of the shorter-wavelength light of the disparity test light may be boosted by collecting the disparity test light from multiple paths within the waveguide. At least a portion of the disparity test light (in particular, light with shorter wavelengths, such as blue light) may be diffracted by the output gratings to propagate in a secondary path different from the primary path of the display light. Disparity test light on the secondary path can have a larger incident angle on surfaces of the waveguide such that the distance travelled by the disparity test light between every other reflection may be longer in the propagation direction, and thus may have fewer interactions with the waveguide and the output gratings. Therefore, the secondary path may be shorter than the primary path and may include fewer interactions between the disparity test light and the waveguide/gratings, and thus may have lower loss (e.g., due to absorption and/or other losses such as diffraction by gratings on the path) for the disparity test light than the primary path. By collecting the disparity test light from the secondary path as well as the primary path, the signal strength of the disparity test light (in particular, light with shorter wavelengths, such as blue light) collected by the disparity sensor may be improved significantly (e.g., 40 times or higher). The secondary path may already be supported by the input grating(s) and the output grating(s) for display light, and thus no modification to the input grating(s) and the output grating(s) of the waveguide display may be needed.

In one example, a waveguide display system may include a projector configured to project both display light and disparity test light, a waveguide transparent to visible light, an input coupler configured to couple the display light and the disparity test light into the waveguide, and a set of output gratings configured to replicate the display light in one or two dimensions and also direct the disparity test light to propagate along two different paths in the waveguide. The waveguide display system may also include a first disparity grating configured to couple a first portion of the disparity test light propagating along a first path of the two different paths out of the waveguide to a disparity sensor, and a second disparity grating configured to couple a second portion of the disparity test light propagating along a second path of the two different paths out of the waveguide to the disparity sensor. The first disparity grating and the second disparity grating may have different grating vectors (e.g., different grating periods and/or different orientations), and may be gratings (e.g., surface-relief gratings or holographic gratings) on opposing surfaces of the waveguide or on different regions of a surface of the waveguide. In some embodiments, the first disparity grating and the second disparity grating may be on a same region of a surface of the waveguide and may form a two-dimensional grating. The disparity test light coupled out of the first disparity grating may align with the disparity test light coupled out of the second disparity grating such that they may form a same image on the disparity sensor. In some embodiments, the second portion of the disparity test light may only include short-wavelength light, such as blue light. The waveguide display system may be configured such that the disparity test light from the first path and the second path may reach the disparity gratings from appropriate angles so that the disparity test light coupled out of the waveguide may be incident on the disparity sensor from desired fields of view of the disparity sensor.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

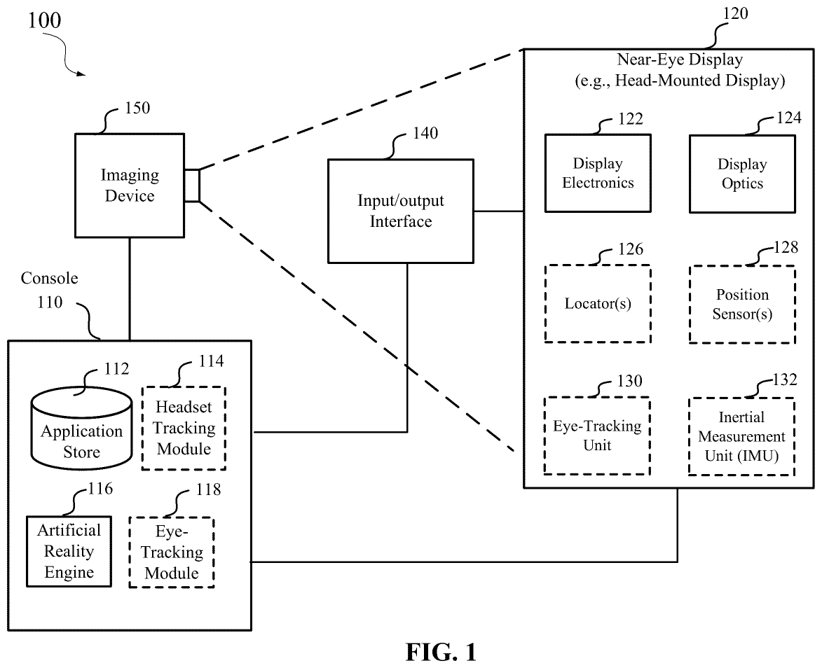

FIG. 1 is a simplified block diagram of an example of an artificial reality system environment 100 including a near-eye display 120 in accordance with certain embodiments.

Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

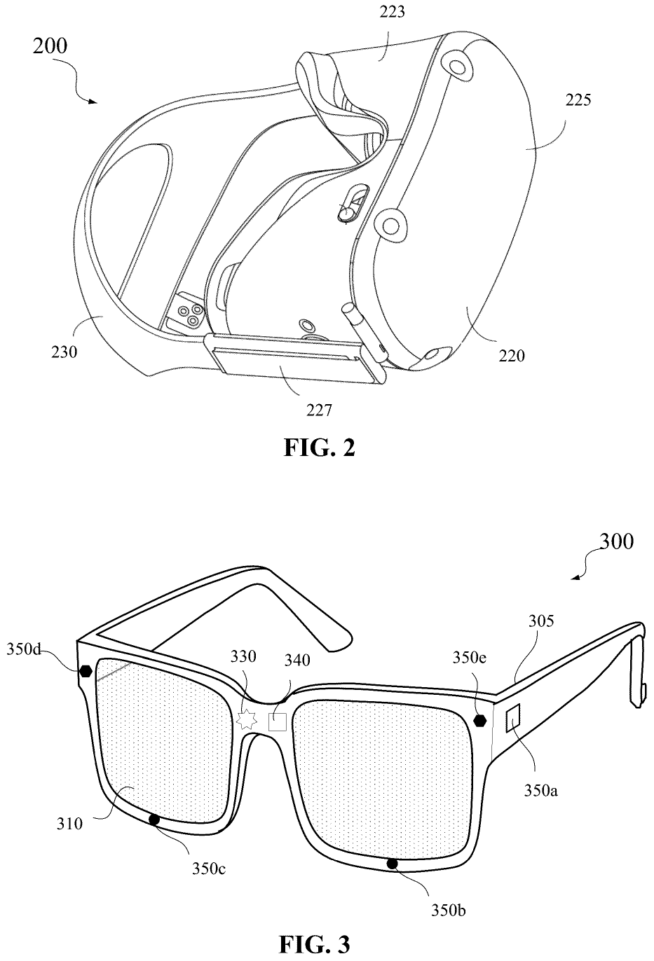

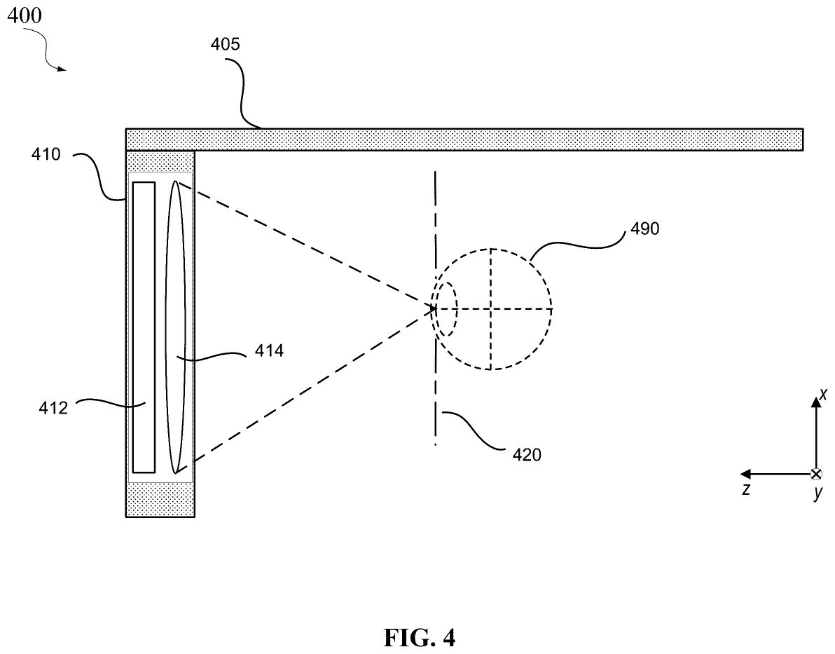

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an antireflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be a light-emitting diode (LED), a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 12 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 120 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking subsystem 114, an artificial reality engine 116, and an eye-tracking subsystem 118. Some embodiments of console 110 may include different or additional devices or subsystems than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the devices or subsystems of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking subsystem 114 may track movements of near-eye display 120 using slow calibration information from external imaging device 150. For example, headset tracking subsystem 114 may determine positions of a reference point of near-eye display 120 using observed locators from the slow calibration information and a model of near-eye display 120. Headset tracking subsystem 114 may also determine positions of a reference point of near-eye display 120 using position information from the fast calibration information. Additionally, in some embodiments, headset tracking subsystem 114 may use portions of the fast calibration information, the slow calibration information, or any combination thereof, to predict a future location of near-eye display 120. Headset tracking subsystem 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking subsystem 114. Artificial reality engine 116 may also receive estimated eye position and orientation information from eye-tracking subsystem 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking subsystem 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking subsystem 118 to more accurately determine the eye's orientation.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eyebox regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350c on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. High-resolution camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

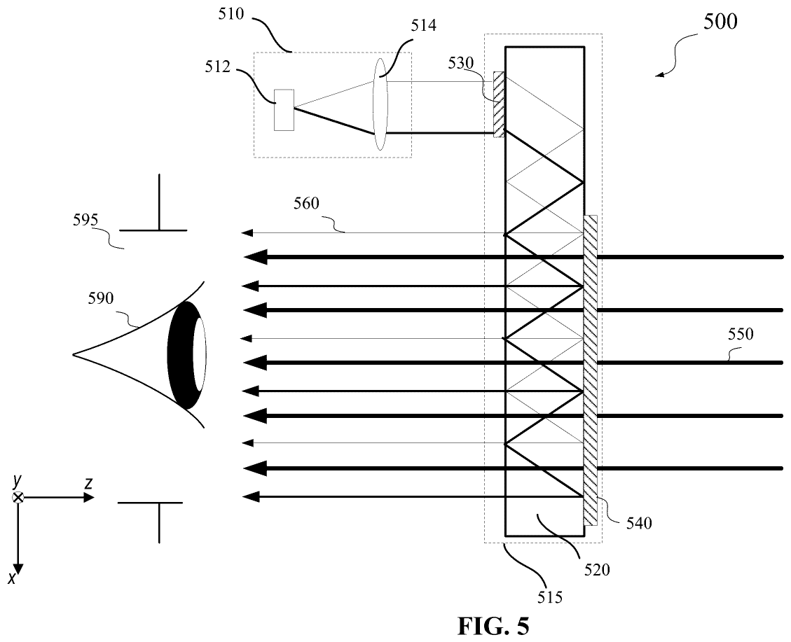

FIG. 4 is a cross-sectional view of an example of a near-eye display 400 according to certain embodiments. Near-eye display 400 may include at least one display assembly 410. Display assembly 410 may be configured to direct image light (e.g., display light) to an eyebox located at an exit pupil 420 and to user's eye 490. It is noted that, even though FIG. 4 and other figures in the present disclosure show an eye of a user of the near-eye display for illustration purposes, the eye of the user is not a part of the corresponding near-eye display.

As HMD device 200 and near-eye display 300, near-eye display 400 may include a frame 405 and display assembly 410 that may include a display 412 and/or display optics 414 coupled to or embedded in frame 405. As described above, display 412 may display images to the user electrically (e.g., using LCDs, LEDs, OLEDs) or optically (e.g., using a waveguide display and optical couplers) according to data received from a processing unit, such as console 110. In some embodiments, display 412 may include a display panel that includes pixels made of LCDs, LEDs, OLEDs, and the like. Display 412 may include sub-pixels to emit light of a predominant color, such as red, green, blue, white, or yellow. In some embodiments, display assembly 410 may include a stack of one or more waveguide displays including, but not restricted to, a stacked waveguide display, a varifocal waveguide display, and the like. The stacked waveguide display may be a polychromatic display (e.g., a red-green-blue (RGB) display) created by stacking waveguide displays whose respective monochromatic sources are of different colors.

Display optics 414 may be similar to display optics 124 and may display image content optically (e.g., using optical waveguides and optical couplers), correct optical errors associated with the image light, combine images of virtual objects and real objects, and present the corrected image light to exit pupil 420 of near-eye display 400, where the user's eye 490 may be located. In some embodiments, display optics 414 may also relay the images to create virtual images that appear to be away from display 412 and further than just a few centimeters away from the eyes of the user. For example, display optics 414 may collimate the image source to create a virtual image that may appear to be far away (e.g., greater than about 0.3 m, such as about 0.5 m, 1 m, or 3 m away) and convert spatial information of the displayed virtual objects into angular information. In some embodiments, display optics 414 may also magnify the source image to make the image appear larger than the actual size of the source image. More details of display 412 and display optics 414 are described below.

In various implementations, the optical system of a near-eye display, such as an HMD, may be pupil-forming or non-pupil-forming. Non-pupil-forming HMDs may not use intermediary optics to relay the displayed image, and thus the user's pupils may serve as the pupils of the HMD. Such non-pupil-forming displays may be variations of a magnifier (sometimes referred to as “simple eyepiece”), which may magnify a displayed image to form a virtual image at a greater distance from the eye. The non-pupil-forming display may use fewer optical elements. Pupil-forming HMDs may use optics similar to, for example, optics of a compound microscope or telescope, and may include some forms of projection optics that magnify an image and relay it to the exit pupil.

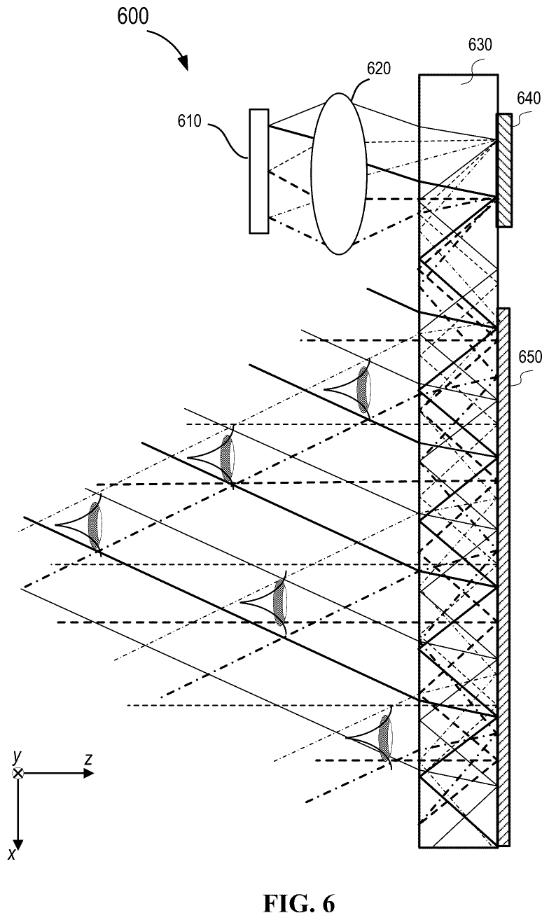

FIG. 5 illustrates an example of an optical see-through augmented reality system 500 including a waveguide display according to certain embodiments. Augmented reality system 500 may include a projector 510 and a combiner 515. Projector 510 may include a light source or image source 512 and projector optics 514. In some embodiments, light source or image source 512 may include one or more micro-LED devices described above. In some embodiments, image source 512 may include a plurality of pixels that displays virtual objects, such as an LCD display panel or an LED display panel. In some embodiments, image source 512 may include a light source that generates coherent or partially coherent light. For example, image source 512 may include a laser diode, a vertical cavity surface emitting laser, an LED, and/or a micro-LED described above. In some embodiments, image source 512 may include a plurality of light sources (e.g., an array of micro-LEDs described above), each emitting a monochromatic image light corresponding to a primary color (e.g., red, green, or blue). In some embodiments, image source 512 may include three two-dimensional arrays of micro-LEDs, where each two-dimensional array of micro-LEDs may include micro-LEDs configured to emit light of a primary color (e.g., red, green, or blue). In some embodiments, image source 512 may include an optical pattern generator, such as a spatial light modulator. Projector optics 514 may include one or more optical components that can condition the light from image source 512, such as expanding, collimating, scanning, or projecting light from image source 512 to combiner 515. The one or more optical components may include, for example, one or more lenses, liquid lenses, mirrors, apertures, and/or gratings. For example, in some embodiments, image source 512 may include one or more one-dimensional arrays or elongated two-dimensional arrays of micro-LEDs, and projector optics 514 may include one or more one-dimensional scanners (e.g., micro-mirrors or prisms) configured to scan the one-dimensional arrays or elongated two-dimensional arrays of micro-LEDs to generate image frames. In some embodiments, projector optics 514 may include a liquid lens (e.g., a liquid crystal lens) with a plurality of electrodes that allows scanning of the light from image source 512.

Combiner 515 may include an input coupler 530 for coupling light from projector 510 into a substrate 520 of combiner 515. Input coupler 530 may include a volume holographic grating, a diffractive optical element (DOE) (e.g., a surface-relief grating), a slanted surface of substrate 520, or a refractive coupler (e.g., a wedge or a prism). For example, input coupler 530 may include a reflective volume Bragg grating or a transmissive volume Bragg grating. Input coupler 530 may have a coupling efficiency of greater than 30%, 60%, 75%, 90%, or higher for visible light. Light coupled into substrate 520 may propagate within substrate 520 through, for example, total internal reflection (TIR). Substrate 520 may be in the form of a lens of a pair of eyeglasses. Substrate 520 may have a flat or a curved surface, and may include one or more types of dielectric materials, such as glass, quartz, plastic, polymer, poly(methyl methacrylate) (PMMA), crystal, SiN, SiC, or ceramic. A thickness of the substrate may range from, for example, less than about 1 mm to about 12 mm or more. Substrate 520 may be transparent to visible light.

Substrate 520 may include or may be coupled to a plurality of output couplers 540. each configured to extract at least a portion of the light guided by and propagating within substrate 520 from substrate 520, and direct extracted light 560 to an eyebox 595 where an eye 590 of the user of augmented reality system 500 may be located when augmented reality system 500 is in use. The plurality of output couplers 540 may replicate the exit pupil to increase the size of eyebox 595 such that the displayed image is visible in a larger area. As input coupler 530, output couplers 540 may include grating couplers (e.g., volume holographic gratings or surface-relief gratings), other diffraction optical elements, prisms, etc. For example, output couplers 540 may include reflective volume Bragg gratings or transmissive volume Bragg gratings. Output couplers 540 may have different coupling (e.g., diffraction) efficiencies at different locations. Substrate 520 may also allow light 550 from the environment in front of combiner 515 to pass through with little or no loss. Output couplers 540 may also allow light 550 to pass through with little loss. For example, in some implementations, output couplers 540 may have a very low diffraction efficiency for light 550 such that light 550 may be refracted or otherwise pass through output couplers 540 with little loss, and thus may have a higher intensity than extracted light 560. In some implementations, output couplers 540 may have a high diffraction efficiency for light 550 and may diffract light 550 in certain desired directions (i.e., diffraction angles) with little loss. As a result, the user may be able to view combined images of the environment in front of combiner 515 and images of virtual objects projected by projector 510.

In some embodiments, projector 510, input coupler 530, and output coupler 540 may be on any side of substrate 520. Input coupler 530 and output coupler 540 may be reflective gratings (also referred to as reflective gratings) or transmissive gratings (also referred to as transmissive gratings) to couple display light into or out of substrate 520.

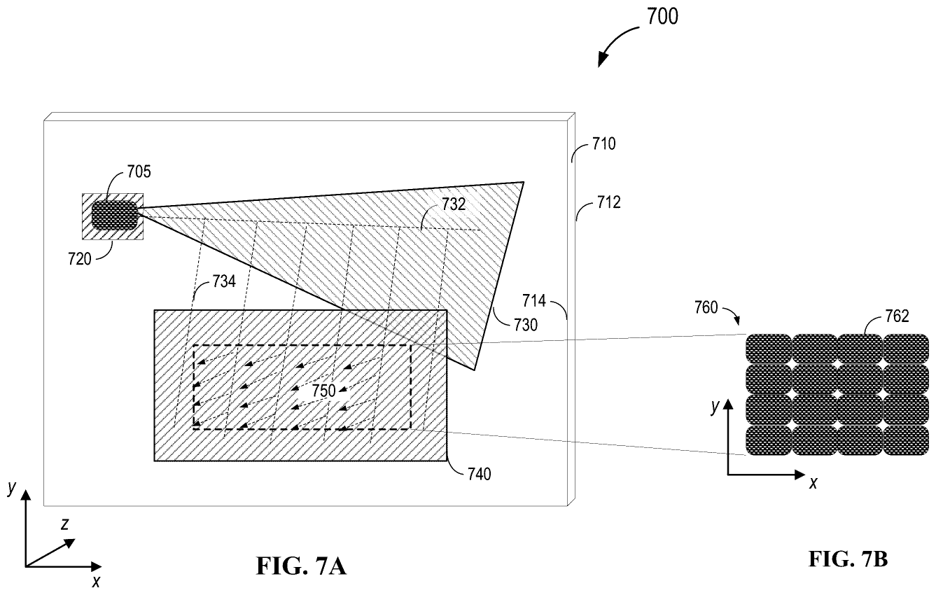

FIG. 6 illustrates an example of an optical see-through augmented reality system 600 including a waveguide display for exit pupil expansion according to certain embodiments. Augmented reality system 600 may be similar to augmented reality system 600, and may include the waveguide display and a projector that may include a light source or image source 610 and projector optics 620. The waveguide display may include a substrate 630, an input coupler 640, and a plurality of output couplers 650 as described above with respect to augmented reality system 600. While FIG. 6 only shows the propagation of light from a single field of view, FIG. 6 shows the propagation of light from multiple fields of view.

FIG. 6 shows that the exit pupil is replicated by output couplers 650 to form an aggregated exit pupil or eyebox, where different regions in a field of view (e.g., different pixels on image source 610) may be associated with different respective propagation directions towards the eyebox, and light from a same field of view (e.g., a same pixel on image source 610) may have a same propagation direction for the different individual exit pupils. Thus, a single image of image source 610 may be formed by the user's eye located anywhere in the eyebox, where light from different individual exit pupils and propagating in the same direction may be from a same pixel on image source 610 and may be focused onto a same location on the retina of the user's eye. In other words, the user's eye may convert angular information in the eyebox or exit pupil (e.g., corresponding to a Fourier plane) to spatial information in images form on the retina. FIG. 6 shows that the image of the image source is visible by the user's eye even if the user's eye moves to different locations in the eyebox.

FIGS. 5 and 6 show that light of projected images may be coupled into a waveguide (e.g., a transparent substrate), propagate within the waveguide through total internal reflection, and be coupled out of the waveguide at multiple locations to replicate the exit pupil and expand the eyebox in one dimension. In some implementations, multiple waveguides and/or multiple couplers (e.g., gratings or transflective mirrors) may be used to replicate the exit pupil in two dimensions to fill a large eyebox (e.g., 40×40 mm² or larger) with a 2D array of pupils (e.g., each about 2×2 mm²), thereby expanding the eyebox such that the user's eyes can view the displayed images even if the user's eyes move within a large area. For example, two or more gratings may be used to expand the display light in two dimensions or along two axes. The two gratings may have different grating parameters, such that one grating may be used to replicate the exit pupil in one direction and the other grating may be used to replicate the exit pupil in another direction.

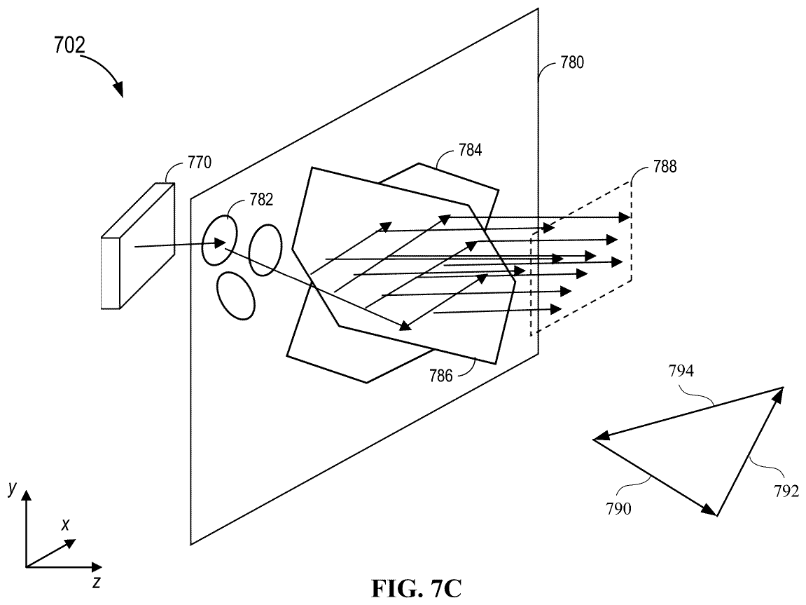

FIG. 7A illustrates an example of an optical see-through augmented reality system including a waveguide display 700 and surface-relief gratings for exit pupil expansion according to certain embodiments. Waveguide display 700 may include a substrate 710, which may function as a waveguide and may be similar to substrate 520 or 630. Substrate 710 may be transparent to visible light and may include, for example, a glass, quartz, plastic, polymer, PMMA, ceramic, Si₃N₄, SiC, or crystal substrate. Substrate 710 may be a flat substrate or a curved substrate. Substrate 710 may include a first surface 712 and a second surface 714. Display light may be coupled into substrate 710 by an input coupler 720, and may be reflected by first surface 712 and second surface 714 through total internal reflection, such that the display light may propagate within substrate 710. Input coupler 720 may include one or more gratings, a refractive coupler (e.g., a wedge or a prism), or a reflective coupler (e.g., a reflective surface having a slant angle with respect to substrate 710). For example, in one embodiment, input coupler 720 may include a prism that may couple display light of different colors into substrate 710. In another example, input coupler 720 may include one or more grating couplers that may diffract light of different colors into substrate 710 at different directions. Input coupler 720 may have a coupling efficiency of greater than 10%, 20%, 30%, 50%, 75%, 90%, or higher for visible light.

Waveguide display 700 may also include a first output grating 730 and a second output grating 740 positioned on one or two surfaces (e.g., first surface 712 and second surface 714) of substrate 710 for expanding incident display light beam in two dimensions in order to fill an eyebox 750 with the display light. Display light coupled into substrate 710 may propagate in a direction shown by a line 732. While the display light propagates within substrate 710 along a direction shown by line 732, a portion of the display light may be diffracted by a region of first output grating 730 towards second output grating 740 as shown by a line 734, each time the display light propagating within substrate 710 reaches first output grating 730. Therefore, first output grating 730 may be configured to expand at least a portion of the display light along one direction, such as approximately in the x direction. Second output grating 740 may then expand each display light beam from first output grating 730 in a different direction (e.g., approximately in the y direction) by diffracting a portion of the display light to eyebox 750 each time the display light propagating within substrate 710 reaches second output grating 740, thereby filling the eyebox 750 with a 2D array of display light beams.

FIG. 7B illustrates an example of an eyebox including a two-dimensional array of replicated exit pupils. FIG. 7B shows that a single input pupil 705 may be replicated by first output grating 730 and second output grating 740 to form an aggregated exit pupil 760 that includes a two-dimensional array of individual exit pupils 762. For example, the exit pupil may be replicated in approximately the x direction by first output grating 730 and in approximately the y direction by second output grating 740. As described above, output light from individual exit pupils 762 and propagating in a same direction may be focused onto a same location in the retina of the user's eye. Thus, a single image may be formed by the user's eye from the output light in the two-dimensional array of individual exit pupils 762.

FIG. 7C is a perspective view of an example of a waveguide display 702 with grating couplers for exit pupil expansion according to certain embodiments. Waveguide display 702 may be an example of waveguide display 700. Waveguide display 702 may include a light source 770, which may include, for example, an array of red micro-LEDs, an array of green micro-LEDs, and an array of blue micro-LEDs. Each array of micro-LEDs may generate an image of a corresponding color, and thus the three arrays of micro-LEDs may generate a color image. Waveguide display 702 may include a substrate 780 with grating couplers formed thereon or coupled thereto. For example, waveguide display 702 may include three input gratings 782, a first output grating 784, and a second output grating 786. Input gratings 782, first output grating 784, and second output grating 786 may include, for example, SRG gratings formed at different locations on surfaces of substrate 780, such as on two opposite broadside surfaces of substrate 780. The grating vectors of an input grating 782, first output grating 784, and second output grating 786 may form a closed triangle.

Each input grating 782 may be used to couple display light of a monochromatic image generated by a corresponding array of micro-LEDs into substrate 780. The display light diffracted by input grating 782 may have a wave vector 790 in the x-y plane in substrate 780. The display light coupled into substrate 780 may propagate within substrate 780 through total internal reflection at the surfaces of substrate 780, and may be diffracted to second output grating 786 by a first output grating 784 at multiple locations along a first direction, thereby replicating the input pupil along the first direction. The display light diffracted by first output grating 784 may have a wave vector 792 in the x-y plane. The display light diffracted at different locations of first output grating 784 may reach second output grating 786, which may diffract the display light at different locations along a second direction to replicate the input pupil along the second direction as described above. The display light diffracted by second output grating 786 may have a wave vector 794 in the x-y plane. The diffracted light may then propagate in air towards an eyebox 788. Wave vectors 790, 792, and 794 may form a closed triangle in the x-y plane.

Misalignments (e.g., relative tip, tilt, and rotation) between the waveguide (e.g., substrate 710 or 780) and the light source (e.g., light source 770 that includes a projector) or relative movement of an assembly that includes a waveguide and the light source for one eye with respect to another assembly for the other eye may cause the display images presented to the left eye and the right eye of the user to be different from the desired two-dimensional (2D) display images that show objects according to binocular disparity such that the user's brain may extract proper depth information from the two 2D images captured by the two eyes through stereopsis. Therefore, the user may see two images of a same object and other undesired optical artifacts, such as illumination and/or color mismatch or non-uniformity, which may degrade the user experience of using the near-eye display system.

In some implementations, to reduce or otherwise mitigate the undesired optical artifacts caused by the misalignment or relative movement described above, a disparity grating (on one side or both sides of the waveguide) may be used on the nasal side of the waveguide for each eye to couple some disparity test light from the light source out of the waveguide at the nasal side of the waveguide. A disparity sensor may detect the light patterns of the disparity test light from each of the two waveguides, to determine the boresight errors between the left image and the right image in the binocular near-eye display system, such that the projector(s) and/or the displayed images may be adjusted to compensate for the misalignment between the waveguide and light source in an assembly and relative movement between assemblies.

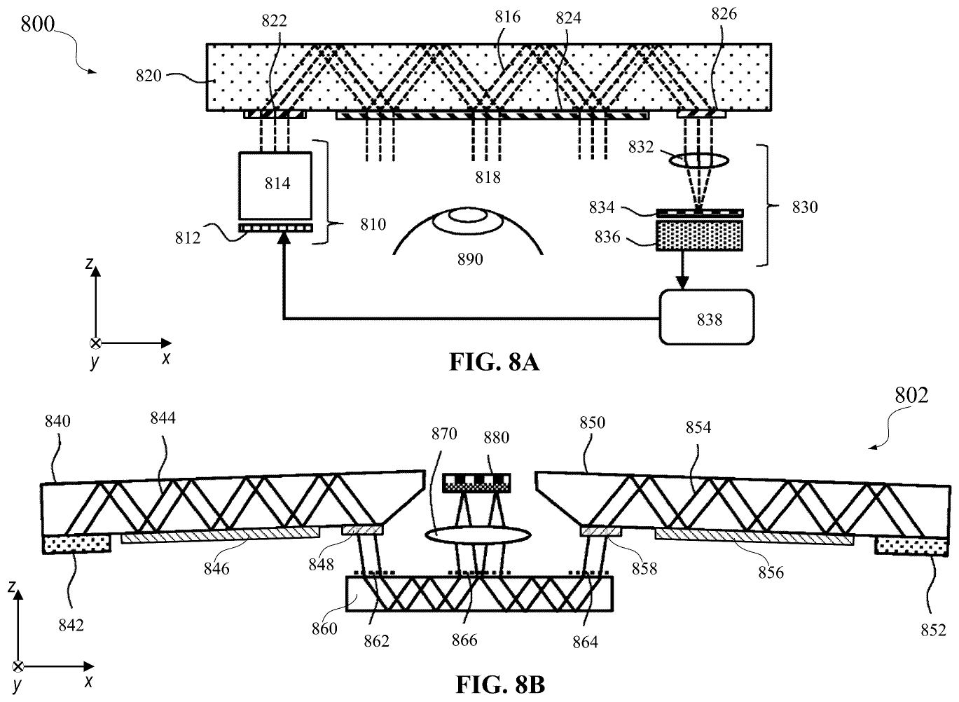

FIG. 8A illustrates an example of a waveguide display 800 including a disparity sensor. In the illustrated example, waveguide display 800 may include a projector 810 providing disparity test light 816 to a waveguide 820. Disparity test light 816 may carry a certain disparity test pattern, such as a fringe pattern. In one example, projector 810 may include a display panel 812 coupled to projector optics 814. In some embodiments, projector 810 may be of a different type, such as a scanning type projector. Projector 810 may be a dual function projector that may provide the disparity test pattern for tilt/disparity sensing and also provide display images for presenting to a user's eye 890. In some embodiments, projector 810 may be used solely for providing the disparity test pattern for waveguide tilt/binocular disparity sensing. The disparity test pattern may be made invisible to the user, for example, by providing a disparity test pattern in invisible light such as near infrared (NIR) or ultraviolet (UV) light, presenting the disparity test pattern outside of the display's field of view (FOV), presenting the disparity test pattern when the user's eye blinks, and the like.

The disparity test pattern and display light may be coupled into waveguide 820 by an input coupler 822, such as a grating coupler, at a first end of waveguide 820. Waveguide 820 may be a one-dimensional or two-dimensional pupil-replicating waveguide as described above, and may carry the disparity test light 816 and the display light by a series of total internal reflections (TIRs) at opposing surfaces of waveguide 820. Waveguide 820 may include at least one output coupler 824, such as a diffraction grating, for out-coupling portions 818 of the display light to the user's eye 890. Waveguide 820 may further include at least one output coupler 826 at an end of waveguide 820 for out-coupling at least a portion of the disparity test light to a receiver 830. Output coupler 826 may be a part of output coupler 824, or may be separate from output coupler 824 buy may have the same grating vector as output coupler 824. In some embodiments, a focusing element 832 (e.g., a lens) may be used to focus the disparity test light from output coupler 826.

A receiver 830 of waveguide display 800 may be configured to receive the disparity test light from waveguide 820. In the illustrated example, receiver 830 may include a mask 834 that may include a reference pattern corresponding to the disparity test pattern. Receiver 830 may also include a photodetector assembly 836, which may be a single-pixel photodetector or a one-dimensional (1D) or two-dimensional (2D) array of photodetectors. Photodetector assembly 836 may be disposed downstream of mask 834 for generating a photodetector signal corresponding to an integrated irradiance of the disparity test light passing through mask 834.

Receiver 830 may further include focusing element 832, such as a lens or a diffractive optical element, where mask 834 may be positioned at or close to the focal plane of focusing element 832.

When waveguide 820 is tilted or rotated relative to projector 810 or is otherwise improperly aligned with projector 810, the disparity test pattern may shift in the angular domain, and thus the disparity test pattern incident on receiver 830 may also shift relative to the reference pattern on mask 834, which may result in a change of the overall transmitted optical power detected by photodetector assembly 836, thereby changing the light signal detected by photodetector assembly 836 and thus the output signal generated by photodetector assembly 836.

Waveguide display 800 may include a controller 838 coupled to projector 810 and photodetector assembly 836. Controller 838 may be configured to cause the projector 810 to provide the disparity test light, receive the output signal from photodetector assembly 836, and determine the tilt or other misalignments of waveguide 820 with respect to projector 810 based on the output signal generated by photodetector assembly 836. For example, the tilt or other misalignments may be determined based on the magnitude of the output signal of a single-pixel photodetector, or a comparison of signals from different pixels/photodetector elements of a multi-pixel detector assembly or a detector array. In some embodiments, the disparity test pattern may include a first periodic pattern having a first period at the focal plane of focusing element 832, and the reference pattern on mask 834 may include a second periodic pattern having a second period. The first period and the second period may be the same, or may differ from one another. For example, the first period may differ from the second period by less than 25% of the first period. In some embodiments, controller 838 may be configured to shift the disparity test pattern laterally by a plurality of different shift amounts, receive a signal from photodetector assembly 836 for each shift amount of the plurality of different shift amounts of the disparity test pattern, and compare a received photodetector signal to the photodetector signals for the different shift amounts to determine the tilt or other misalignment between projector 810 and waveguide 820.

FIG. 8B illustrates an example of a near-eye display 802 including a waveguide for coupling disparity test light from two pupil-replicating waveguides to a common photodetector array for binocular disparity sensing. In the example illustrated in FIG. 8B, near-eye display 802 may include a first pupil-replicating waveguide 840, a second pupil-replicating waveguide 850, a waveguide 860, a focusing element 870, and a receiver 880.

First pupil-replicating waveguide 840 may be similar to waveguide 820 described above, and may include an input grating 842 for couple disparity test light and display light 844 into first pupil-replicating waveguide 840, one or more output gratings 846 configured to couple portions of display light 844 out of first pupil-replicating waveguide 840 to an eyebox for the left eye of the user, and one or more disparity gratings 848 configured to couple the disparity test light out of first pupil-replicating waveguide 840. The disparity test light coupled out of first pupil-replicating waveguide 840 may be coupled into waveguide 860 by an input coupler 862 and coupled out of waveguide 860 by an output coupler 866 towards focusing element 870 and receiver 880. Waveguide 860 may be a one-dimensional waveguide and may guide the in-coupled disparity test light to propagate in one direction (e.g., the x direction), which is different from first pupil-replicating waveguide 840 and second pupil-replicating waveguide 850 that may each guide the in-coupled light in two directions.

Second pupil-replicating waveguide 850 may be similar to waveguide 820 and first pupil-replicating waveguide 840 described above, and may include an input grating 852 for couple disparity test light and display light 854 into second pupil-replicating waveguide 850, one or more output gratings 856 configured to couple portions of display light 854 out of second pupil-replicating waveguide 850 to an eyebox for the right eye of the user, and one or more disparity gratings 858 configured to couple the disparity test light out of second pupil-replicating waveguide 850. The disparity test light coupled out of second pupil-replicating waveguide 850 may be coupled into waveguide 860 by an input coupler 864 and coupled out of waveguide 860 by output coupler 866 towards focusing element 870 and receiver 880.

The disparity test light coupled out of second pupil-replicating waveguide 850 and the disparity test light coupled out of first pupil-replicating waveguide 840 may be focused by focusing element 870 to form an image on the photodetector array of receiver 880. The relative position of the disparity test patterns from first pupil-replicating waveguide 840 and second pupil-replicating waveguide 850 may indicate a tilt angle or other misalignment or relative movement of first pupil-replicating waveguide 840 with respect to second pupil-replicating waveguide 850. When a relative tilt or another misalignment or relative movement is detected, the display image generated by the left projector and/or the display image generated by the right projector may be digitally adjusted to compensate the relative tilt or another misalignment or relative movement.

In some implementations, the disparity test light coupled out of second pupil-replicating waveguide 850 and the disparity test light coupled out of first pupil-replicating waveguide 840 may be directed by a reflector assembly to focusing element 870. In one example, the reflector assembly may include a pair of prisms for each of the left side and the right side. In another example, the reflector assembly may include a pair of mirrors for each of the left side and the right side.

In the waveguide displays and near-eye displays described above, it can be challenging to couple sufficiently high disparity test light signal at the nasal side of the waveguide to a disparity sensor for fast and accurate detection by the disparity sensor, in particular, for light with shorter wavelengths. For example, in some waveguide display systems, the orientation (e.g., the clocking angle) and the period of a disparity grating may match the grating of an output coupler (referred to as an output grating) for display light, and the disparity test light signal (e.g., having a certain image pattern) may follow the same path as the display light. Therefore, a large portion of the disparity test light signal may be coupled out of the waveguide by the output grating before the disparity test light signal could reach the disparity grating. As such, the intensity of the disparity test light signal that may reach the disparity grating and be coupled out of the waveguide to the disparity sensor by the disparity grating may be very low. In particular, in a single-layer waveguide design (where red light, green light, and blue light propagate in the same waveguide), the blue light (or other light having a shorter wavelength and thus a smaller diffraction angle) may interact with the waveguide and the output gratings more times and may travel a much longer distance on the propagation path in the waveguide than the red light (or other light having a longer wavelength). As such, the intensity of the blue light coupled out of the waveguide by the disparity grating may be too low and may not be sufficient for accurate detection by the disparity sensor.

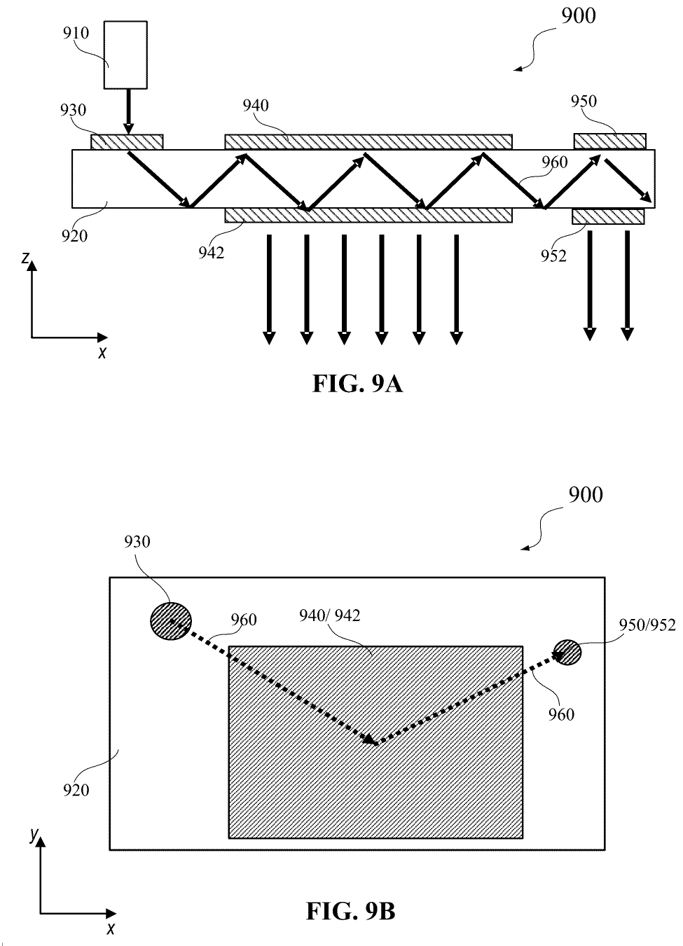

FIG. 9A illustrates an example of a waveguide display 900 including one or more disparity gratings. Waveguide display 900 may be used as, for example, first pupil-replicating waveguide 840 or second pupil-replicating waveguide 850 described above. In the illustrated example, waveguide display 900 may include a projector 910 and a waveguide 920. Projector 910 may be similar to projector 810 described above and may be configured to project display images and/or disparity test patterns. Waveguide 920 may include a substrate (e.g., a SiC substrate or another material with a high refractive index and thus can guide light in a large field of view) and a plurality of grating couplers formed thereon, and may be used for two-dimensional pupil expansion as described above. The plurality of grating couplers may include, for example, an input grating 930, a first output grating 940, a second output grating 942, a first disparity grating 950, and a second disparity grating 952.

Display images and disparity test patterns projected by projector 910 may be coupled into waveguide 920 by input grating 930 and may propagate within waveguide 920 through total internal reflections. The display light and disparity test light 960 may reach first output grating 940 and may be reflectively diffracted towards second output grating 942 by first output grating 940 at multiple locations along a first direction (e.g., the x direction). Second output grating 942 may diffract the display light and disparity test light 960 towards an eyebox at multiple locations along a second direction (e.g., the y direction). First disparity grating 950 and second disparity grating 952 may have grating vectors similar to the grating vector of second output grating 942 and thus may couple at least a portion of the remaining display light and disparity test light 960 out of waveguide 920 towards a disparity sensor.

FIG. 9B illustrates an example of the propagation path of disparity test light in waveguide display 900. As illustrated, disparity test light 960 may be diffracted by input grating 930 towards first output grating 940 and/or second output grating 942. Disparity test light 960 may be diffracted by first output grating 940 to change the propagation direction towards second output grating 942, first disparity grating 950, and second disparity grating 952. Second output grating 942, first disparity grating 950, and second disparity grating 952 may couple portions of disparity test light 960 out of waveguide 920. Thus, disparity test light 960 may travel a long distance before it may be coupled out of waveguide 920 by disparity gratings 950 and 952 and reach the disparity sensor. As such, a large amount of disparity test light 960 may be lost on the path due to, for example, limited diffraction efficiency of input grating 930 and first output grating 940, diffraction by second output grating 942 out of waveguide 920 on the path, and absorption by waveguide 920 along the path. In particular, for light of a shorter wavelength, such as blue light, the diffraction angle at input grating 930 may be smaller, and thus the distance travelled by blue light between every other reflection along the propagation direction in waveguide 920 may be shorter. As such, blue light may be reflected more times than red light on a longer propagation path from input grating 930 to first disparity grating 950 and second disparity grating 952, and thus may be diffracted more times by second output grating 942 than red light. As a result, the blue light of the disparity test light that reaches the disparity sensor may have a much lower intensity than red light or green light due to losses on the propagation path.

Simulation results show that, in a single-layer waveguide design (e.g., a waveguide including a single SiC substrate or another high refractive index material), it can be very challenging to optimize the output grating and the disparity grating for co-optimization of the efficiency of coupling display light to the eyebox and the efficiency of coupling disparity test light signal to the disparity sensor. In particular, in a single-layer waveguide as shown in FIGS. 9A and 9B, the co-optimization may not be able to achieve a sufficiently high efficiency (e.g., with the end-to-end efficiency greater than about 0.00025%) for the blue channel of the disparity test light.

According to certain embodiments, the signal level of the shorter-wavelength light of the disparity test light may be boosted by collecting the disparity test light from multiple paths within the waveguide. At least a portion of the disparity test light (in particular, light with shorter wavelengths, such as blue light) may be diffracted by the output gratings to propagate in a secondary path different from the primary path of the display light. Disparity test light on the secondary path can have a larger incident angle on surfaces of the waveguide such that the distance travelled by the disparity test light between every other reflection may be longer in the propagation direction, and thus may have fewer interactions with the waveguide and the output gratings. Therefore, the secondary path may be shorter than the primary path and may include fewer interactions between the disparity test light and the waveguide/gratings, and thus may have lower loss (e.g., due to absorption and/or other losses such as diffraction by gratings on the path) for the disparity test light than the primary path. By collecting the disparity test light from the secondary path as well as the primary path, the signal strength of the disparity test light (in particular, light with shorter wavelengths, such as blue light) collected by the disparity sensor may be improved significantly (e.g., 40 times or higher). The secondary path may already be supported by the input grating(s) and the output grating(s) for display light, and thus no modification to the input grating(s) and the output grating(s) of the waveguide display may be needed.

In one example, a waveguide display system may include a projector configured to project both display light and disparity test light, a waveguide transparent to visible light, an input coupler configured to couple the display light and the disparity test light into the waveguide, and a set of output gratings configured to replicate the display light in one or two dimensions and also direct the disparity test light to propagate along two different paths in the waveguide. The waveguide display system may also include a first disparity grating configured to couple a first portion of the disparity test light propagating along a first path of the two different paths out of the waveguide to a disparity sensor, and a second disparity grating configured to couple a second portion of the disparity test light propagating along a second path of the two different paths out of the waveguide to the disparity sensor. The first disparity grating and the second disparity grating may have different grating vectors (e.g., different grating periods and/or different orientations), and may be gratings (e.g., surface-relief gratings or holographic gratings) on opposing surfaces of the waveguide or on different regions of a surface of the waveguide. In some embodiments, the first disparity grating and the second disparity grating may be on a same region of a surface of the waveguide and may form a two-dimensional grating. The disparity test light coupled out of the first disparity grating may align with the disparity test light coupled out of the second disparity grating such that they may form a same image on the disparity sensor. In some embodiments, the second portion of the disparity test light may only include short-wavelength light, such as blue light. The waveguide display system may be configured such that the disparity test light from the first path and the second path may reach the disparity gratings from appropriate angles so that the disparity test light coupled out of the waveguide may be incident on the disparity sensor from desired fields of view of the disparity sensor.

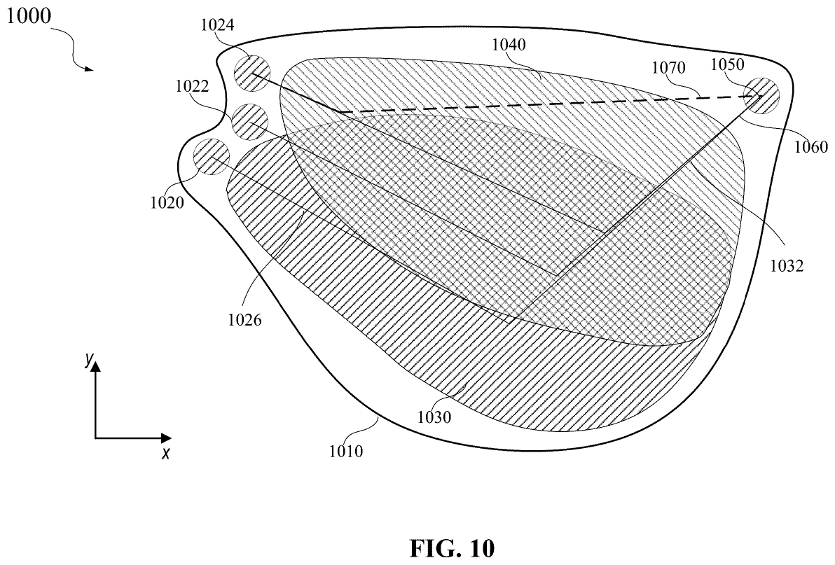

FIG. 10 illustrates an example of a waveguide display 1000 including one or more disparity gratings according to certain embodiments. Waveguide display 1000 may include a substrate 1010, one or more input gratings, a first output grating 1030, a second output grating 1040, and one or more disparity gratings 1050. In the example shown in FIG. 10, the one or more input gratings may include three input gratings for coupling display light and disparity test light of three different colors. For example, an input grating 1020 may be used to couple red light into substrate 1010, an input grating 1022 may be used to couple green light into substrate 1010, and an input grating 1024 may be used to couple blue light into substrate 1010.

Light coupled into substrate 1010 by the one or more input gratings may be guided by substrate 1010 through total internal reflection to propagate within substrate 1010 along a first direction (e.g., as shown by lines 1026), and may reach first output grating 1030. First output grating 1030 may redirect, at multiple locations along the first direction, the display light and the disparity test light to a second direction (e.g., as shown by lines 1032) towards second output grating 1040. Second output grating 1040 may couple portions of the display light and the disparity test light out of substrate 1010 at multiple locations along both the first direction and the second direction to produce a two-dimensional array of exit pupils to fill the eyebox as described above. At least a portion 1060 of the disparity test light redirected by first output grating 1030 may reach the one or more disparity gratings 1050. The one or more disparity gratings 1050 may include a disparity grating having the same or similar grating vectors as second output grating 1040, and thus may at least partially couple the portion 1060 of the disparity test light out of substrate 1010 towards a disparity sensor. The disparity test light that is redirected by first output grating 1030 towards second output grating 1040 and eventually reach the one or more disparity gratings 1050 may travel a longer path (referred to as the primary path). Due to losses such as absorption and/or out-coupling by second output grating 1040 on the primary path, the end-to-end efficiency of the primary path may be very low, in particular, for light with shorter wavelengths, such as blue light, due to, for example, more interactions of the light with shorter wavelengths with substrate 1010, first output grating 1030, and second output grating 1040 as described above.

In the example shown in FIG. 10, the blue light coupled into substrate 1010 by input grating 1024 may reach second output grating 1040 before being diffracted by first output grating 1030, where a portion 1070 of the blue light may be redirected by second output grating 1040 (e.g., due to negative interactions in negative diffraction orders) to propagate towards the one or more disparity gratings 1050. The portion 1070 of the blue light may have a larger incident angle at surfaces of substrate 1010 such that the distance travelled by the portion 1070 of the blue light between every other reflection by surfaces of substrate 1010 may be longer in the propagation direction, and thus may have fewer interactions with surfaces of substrate 1010 and the output gratings. At least one of the one or more disparity gratings 1050 may have a grating vector different from the grating vector of second output grating 1040 and may be configured to couple the blue light from second output grating 1040 out of substrate 1010 towards the disparity sensor. The portion 1070 of the blue light redirected by second output grating 1040 and reaching the one or more disparity gratings 1050 may travel a much shorter path (referred to as the secondary path) before reaching the one or more disparity gratings 1050, and may not be coupled out of substrate 1010 by second output grating 1040 or first output grating 1030 along the secondary path. Therefore, the end-to-end efficiency of the secondary path may be relatively high. The combination of the disparity test light along the primary path and the secondary path may increase the overall intensity of the disparity test light incident on the disparity sensor.

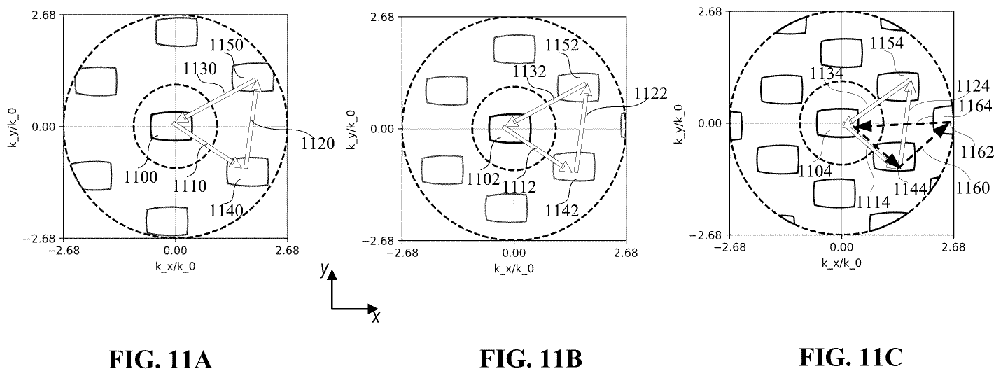

FIGS. 11A-11C illustrate examples of wave vectors of disparity test light and display light of different colors guided by waveguide display 1000 of FIG. 10 according to certain embodiments. In the x-y plane of the k space shown in FIGS. 11A-11C, the ring-shaped region between the inner circle and the outer circle corresponds to the wave vectors of the light that may be guided by substrate 1010. The region within the inner circle corresponds to the wave vectors of the light that would not be guided by substrate 1010 and may be input or output light propagating outside substrate 1010 (e.g., in air).

FIG. 11A shows a region 1100 in the x-y plane of the k space, where region 1100 indicates the field of view (or wave vectors) of the red light of the display light and/or the disparity test light outside of substrate 1010. An arrow 1110 in FIG. 11A shows the diffraction of the red light of the display light and/or the disparity test light by the input grating for red light (e.g., input grating 1020) to couple the red light of the display light and/or the disparity test light into substrate 1010, where a region 1140 indicates the field of view (or wave vectors) of the red light of the display light and/or the disparity test light coupled into substrate 1010 by the input grating and guided by substrate 1010. An arrow 1120 in FIG. 11A shows the diffraction of the red light of the display light and/or the disparity test light by first output grating (e.g., first output grating 1030) to redirect the red light of the display light and/or the disparity test light towards the second output grating (e.g., second output grating 1040) and the disparity grating (e.g., disparity gratings 1050), where a region 1150 indicates the field of view (or wave vectors) of the red light of the display light and/or the disparity test light redirected by the first output grating. An arrow 1130 in FIG. 11A shows the diffraction of the red light of the display light and/or the disparity test light by the disparity grating (e.g., disparity gratings 1050) or the second output grating (e.g., second output grating 1040) to couple the red light of the display light and/or the disparity test light out of substrate 1010.

FIG. 11B shows a region 1102 in the x-y plane of the k space, where region 1102 indicates the field of view of green light of the display light and/or the disparity test light outside of substrate 1010. An arrow 1112 in FIG. 11B shows the diffraction of the green light of the display light and/or the disparity test light by the input grating for green light (e.g., input grating 1022) to couple the green light of the display light and/or the disparity test light into substrate 1010, where a region 1142 indicates the field of view of the green light of the display light and/or the disparity test light coupled into substrate 1010 by the input grating and guided by substrate 1010. An arrow 1122 in FIG. 11B shows the diffraction of the green light of the display light and/or the disparity test light by first output grating (e.g., first output grating 1030) to redirect the green light of the display light and/or the disparity test light towards the second output grating (e.g., second output grating 1040) and the disparity grating (e.g., disparity gratings 1050), where a region 1152 indicates the field of view of the green light of the display light and/or the disparity test light redirected by the first output grating. An arrow 1132 in FIG. 11B shows the diffraction of the green light of the display light and/or the disparity test light by the disparity grating (e.g., disparity gratings 1050) or the second output grating (e.g., second output grating 1040) to couple the green light of the display light and/or the disparity test light out of substrate 1010.

FIG. 11C shows a region 1104 in the x-y plane of the k space, where region 1104 indicates the field of view of blue light of the display light and/or the disparity test light outside of substrate 1010. An arrow 1114 in FIG. 11C shows the diffraction of the blue light of the display light and/or the disparity test light by the input grating for blue light (e.g., input grating 1024) to couple the blue light of the display light and/or the disparity test light into substrate 1010, where a region 1144 indicates the field of view of the blue light of the display light and/or the disparity test light coupled into substrate 1010 by the input grating and guided by substrate 1010. An arrow 1124 in FIG. 11C shows the diffraction of the blue light of the display light and/or the disparity test light by first output grating (e.g., first output grating 1030) to redirect the blue light of the display light and/or the disparity test light towards the second output grating (e.g., second output grating 1040) and the disparity grating (e.g., disparity gratings 1050), where a region 1154 indicates the field of view of the blue light of the display light and/or the disparity test light redirected by the first output grating. An arrow 1134 in FIG. 11C shows the diffraction of the blue light of the display light and/or the disparity test light by the disparity grating (e.g., a disparity grating 1050 having the same or a similar grating vector as the second output grating) or the second output grating to couple the blue light of the display light and/or the disparity test light out of substrate 1010.

FIG. 11C also shows an arrow 1160 indicating the diffraction of the blue light of the display light and/or the disparity test light from the input grating (e.g., input grating 1024) by second output grating (e.g., second output grating 1040) to redirect the blue light of the display light and/or the disparity test light towards the disparity grating (e.g., disparity gratings 1050), where a region 1162 in the x-y plane of the k space indicates the field of view of the blue light of the display light and/or the disparity test light redirected by the second output grating. An arrow 1164 in FIG. 11C shows the diffraction of the blue light of the display light and/or the disparity test light by a disparity grating (e.g., a disparity grating 1050) to couple the blue light of the display light and/or the disparity test light out of substrate 1010, where the disparity grating may have a grating vector different from the grating vector of second output grating 1040 so as to diffract blue light with wave vectors indicated by region 1162 out of substrate 1010. Therefore, FIG. 11C shows that the blue light may propagate from the input grating to the disparity grating in two paths within substrate 1010, where the primary path may be indicated by arrows 1114, 1124, and 1134, whereas the secondary path may be indicated by arrows 1114, 1160, and 1164.

In the example shown in FIGS. 11A and 11B, the waveguide may not support the secondary path for the red and green light as the red light and green light redirected by the second output grating 1040 on the secondary path may be evanescent and may not be supported by the waveguide. Therefore, there may be minimum or no red or green light on the secondary path.

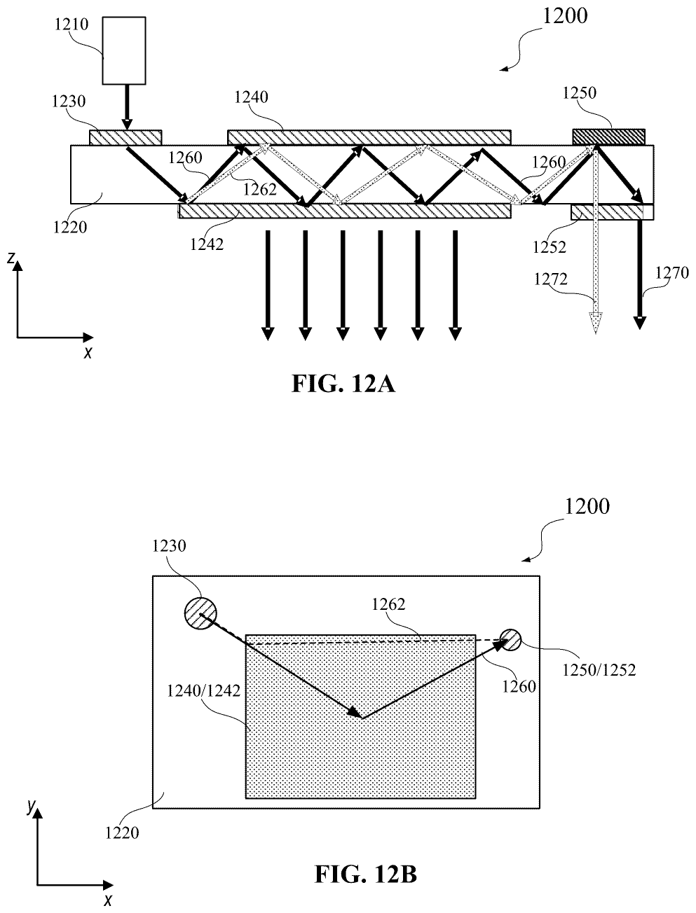

FIG. 12A illustrates an example of a waveguide display 1200 including one or more disparity gratings according to certain embodiments. Waveguide display 1200 may be used as, for example, waveguide display 800, first pupil-replicating waveguide 840, second pupil-replicating waveguide 850, or waveguide display 1000 described above. In the illustrated example, waveguide display 1200 may include a projector 1210 and a waveguide 1220. Projector 1210 may be similar to projector 810 or projector 910 described above, and may be configured to project display images and/or disparity test patterns. Waveguide 1220 may include a substrate (e.g., a SiC substrate or another material with a high refractive index and thus can guide light in a large field of view) and a plurality of grating couplers formed thereon, and may be used for two-dimensional pupil expansion as described above. The plurality of grating couplers may include, for example, an input grating 1230, a first output grating 1240, a second output grating 1242, a first disparity grating 1250, and a second disparity grating 1252.

Disparity test patterns projected by projector 1210 may be coupled into waveguide 1220 by input grating 1230 and propagate within waveguide 1220 through total internal reflection. As described above with respect to FIG. 10, at least a portion 1260 of the disparity test light may reach first output grating 1240 and may be diffracted towards second output grating 1242 by first output grating 1240 at multiple locations along a first direction (e.g., approximately the x direction). Second output grating 1242 may diffract the disparity test light towards an eyebox at multiple locations along a second direction (e.g., approximately the y direction). Second disparity grating 1252 may have grating vectors similar to the grating vector of second output grating 1242 and thus may couple the remaining disparity test light 1270 out of waveguide 1220 towards a disparity sensor.

As illustrated in FIG. 12A, at least a portion 1262 of disparity test light (e.g., a portion of light with shorter wavelengths such as blue light) from input grating 1230 may reach second output grating 1242, and may be redirected by second output grating 1242 (e.g., due to negative interactions in negative diffraction orders as shown in FIG. 11C) to propagate towards first disparity grating 1250. As also shown in FIG. 12A, the portion 1262 of the disparity test light may be incident on surfaces of waveguide 1220 at a larger incident angle, such that the distance travelled by the portion 1262 of the disparity test light between every other reflection by surfaces of waveguide 1220 may be longer in the propagation direction, and thus may have fewer interactions with surfaces of waveguide 1220, first output grating 1240, and second output grating 1242. First disparity grating 1250 may have a grating vector different from the grating vector of second output grating 1242, and may be configured to couple the remaining disparity test light 1272 from second output grating 1242 out of waveguide 1220 towards the disparity sensor as described above with respect to FIG. 11C. Even though FIG. 12A shows first disparity grating 1250 and second disparity grating 1252 on opposing surfaces of waveguide 1220, in some implementation, first disparity grating 1250 and second disparity grating 1252 may be on different regions of a same surface of waveguide 1220, or may be on a same region or overlapped regions of a same surface of waveguide 1220 to form a two-dimensional grating.

FIG. 12B illustrates examples of the paths of disparity test light in waveguide display 1200 according to certain embodiments. As illustrated, the portion 1260 of the disparity test light may be diffracted by input grating 1230 towards first output grating 1240, and may then be diffracted by first output grating 1240 to change the propagation direction towards second output grating 1242, first disparity grating 1250, and second disparity grating 1252. Second output grating 1242 and second disparity grating 1252 may couple portions of the disparity test light out of waveguide 1220. The portion 1262 of the disparity test light may be diffracted by input grating 1230 towards second output grating 1242, and may be diffracted by second output grating 1242 (as shown by arrow 1160 in FIG. 11C) to change the propagation direction towards first disparity grating 1250. First disparity grating 1250 may couple at least a portion of the disparity test light out of waveguide 1220 towards a disparity sensor.

As shown in FIG. 12B, the portion 1260 of the disparity test light may travel a longer distance and may have more interactions with waveguide 1220 and the output gratings 1240 and 1242 than the portion 1262 of the disparity test light before it may be coupled out of waveguide 1220 and reach the disparity sensor, and thus a large amount of the portion 1260 of the disparity test light may be lost on the propagation path due to, for example, limited diffraction efficiency of input grating 1230 and first output grating 1240, diffraction by second output grating 1242 out of waveguide 1220 on the path, and absorption by waveguide 1220 along the path. In particular, for light of a shorter wavelength, such as blue light, the diffraction angle at input grating 1230 may be smaller according to the grating equation, and thus the distance travelled by blue light between every other reflection in waveguide 1220 may be shorter. As such, blue light may be reflected more times than red light and green light on a longer total path from input grating 1230 to second disparity grating 1252, and may be diffracted by second output grating 1242 more times than red light and green light on the path. As a result, the blue light of the portion 1260 of the disparity test light that reaches the disparity sensor may have a much lower intensity than red light or green light.

The portion 1262 of the disparity test light redirected by second output grating 1242 and reaching first disparity grating 1050 may have fewer interactions with waveguide 1220 and the output gratings on a shorter path, and may not be coupled out of waveguide 1220 by second output grating 1242 along the path. Therefore, the end-to-end efficiency of the portion 1262 of the disparity test light may be relatively high. The combination of the disparity test light 1270 and the disparity test light 1272 may provide blue disparity test light with a high intensity to the disparity sensor.

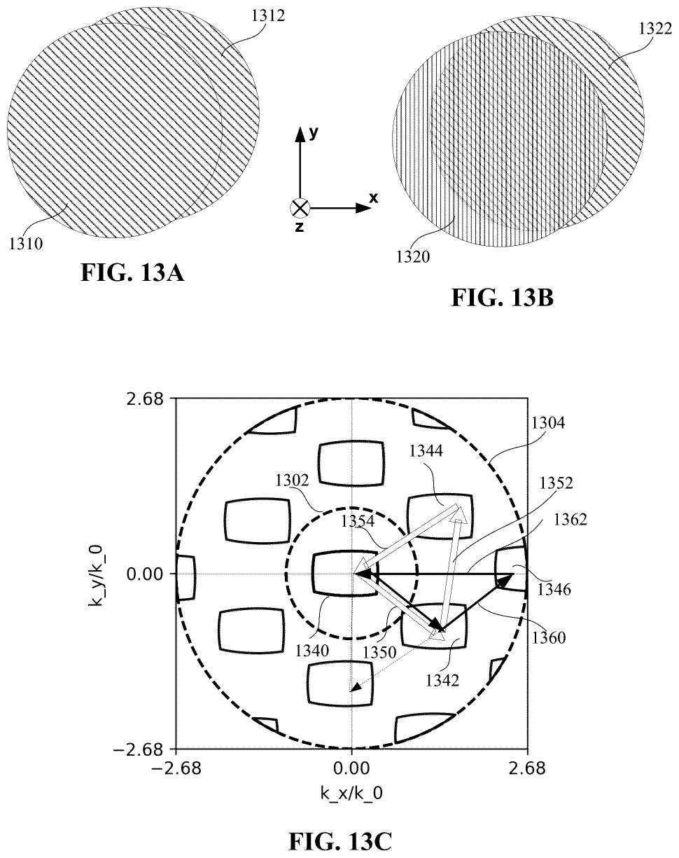

FIG. 13A illustrates an example of a pair of disparity gratings in a waveguide display, such as waveguide display 900. The pair of disparity gratings may include a first disparity grating 1310 and a second disparity grating 1312, which may be an example of first disparity grating 950 and second disparity grating 952, respectively. First disparity grating 1310 and second disparity grating 1312 may be on opposing surfaces of a substrate (e.g., waveguide 920) or may be on different regions of a same surface of the substrate. First disparity grating 1310 and second disparity grating 1312 may have the same grating vector (e.g., same grating period and same orientation such as clocking angle), which may be similar to the grating vector of second output grating 942. As such, first disparity grating 1310 and second disparity grating 1312 may be able to couple the disparity test light redirected by first output grating 940 out of the waveguide, but may not be able to diffract the disparity test light redirected by second output grating 942 out of the waveguide.

FIG. 13B illustrates an example of a pair of disparity gratings in a waveguide display (e.g., waveguide display 1000 or 1200) according to certain embodiments. The pair of disparity gratings may include a first disparity grating 1320 and a second disparity grating 1322, which may be an example of first disparity grating 1250 and second disparity grating 1252. respectively. First disparity grating 1320 and second disparity grating 1322 may be on opposing surfaces of a substrate (e.g., waveguide 1220) or may be on different regions of a surface of the substrate. In some implementation, first disparity grating 1320 and second disparity grating 1322 may be on a same region or overlapped regions of a same surface of the substrate to form a two-dimensional grating. First disparity grating 1320 and second disparity grating 1322 may have different grating vectors (e.g., different grating periods and/or different orientations such as different clocking angles). For example, second disparity grating 1322 may be similar to the grating vector of second output grating 1242, and thus may be able to couple the disparity test light redirected by first output grating 1240 out of the waveguide, but may not be able to diffract the disparity test light redirected by second output grating 1242 out of the waveguide. First disparity grating 1320 may have a grating vector different from the grating vector of second output grating 1242, and may be configured to couple the disparity test light (e.g., blue light of the disparity test light) redirected by second output grating 1242 out of the waveguide.

FIG. 13C illustrates examples of wave vectors of the disparity test light guided by a waveguide display (e.g., waveguide display 1000 or 1200) that includes the pair of disparity gratings of FIG. 13B according to certain embodiments. FIG. 13C show an x-y plane of the k space, where the ring-shaped region between an inner circle 1302 and an outer circle 1304 corresponds to the wave vectors of light that may be guided by the waveguide (e.g., waveguide 1220) of the waveguide display, and the region within inner circle 1302 corresponds to the wave vectors of light that may propagate outside of the waveguide (e.g., in air) and may not be guided by the waveguide. A region 1340 in the x-y plane of the k space indicates the field of view of the disparity test light (e.g., blue light) outside of the waveguide. An arrow 1350 in FIG. 13C shows the diffraction of the disparity test light (e.g., blue light) by the input grating (e.g., input grating 1024 or 1230) to couple the disparity test light into the waveguide, where a region 1342 in the x-y plane of the k space indicates the field of view (and wave vectors) of the disparity test light coupled into the waveguide by the input grating and guided by the waveguide. An arrow 1352 in FIG. 13C shows the diffraction of a first portion of the disparity test light by the first output grating (e.g., first output grating 1240) to redirect the first portion of the disparity test light towards the second output grating (e.g., second output grating 1242) and a disparity grating (e.g., second disparity grating 1252 or 1322), where a region 1344 in the x-y plane of the k space indicates the field of view (and wave vectors) of the first portion of the disparity test light redirected by the first output grating. The disparity grating may have the same grating vector as the second output grating. An arrow 1354 in FIG. 13C shows the diffraction of the first portion of the disparity test light by the second output grating and the disparity grating (e.g., second disparity grating 1252 or 1322) to couple the first portion of the disparity test light out of the waveguide.

FIG. 13C also shows an arrow 1360 indicating the diffraction of a second portion of the disparity test light from the input grating by the second output grating (e.g., second output grating 1242) to redirect the second portion of the disparity test light towards a disparity grating (e.g., first disparity grating 1250 or 1320), where a region 1346 in the x-y plane of the k space indicates the field of view of the second portion of the disparity test light redirected by the second output grating and supported by the waveguide. The disparity grating may have a grating vector different from the grating vector of the second output grating. An arrow 1362 in FIG. 13C shows the diffraction of the second portion of the disparity test light by the disparity grating (e.g., first disparity grating 1250 or 1320) to couple the second portion of the disparity test light out of the waveguide. Therefore, FIG. 13C shows that the disparity test light (e.g., the blue light of the disparity test light) may propagate from the input grating to the disparity gratings in two different paths within the waveguide, where a primary path may be indicated by arrows 1350, 1352, and 1354, whereas a secondary path may be indicated by arrows 1350, 1360, and 1362.

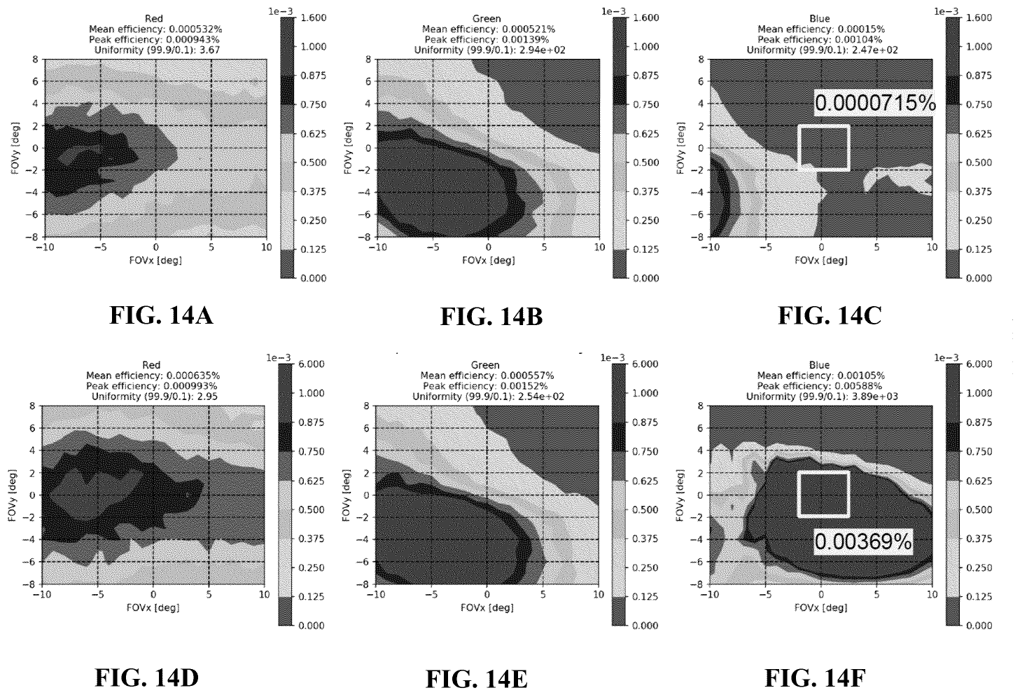

FIGS. 14A-14C illustrate examples of end-to-end efficiencies of disparity test light of different colors in a waveguide display that includes one or more disparity gratings having the same grating vector, such as waveguide display 900. In the examples illustrated in FIGS. 14A-14C, only the disparity test light propagating in the waveguide along a primary path may be coupled out of the waveguide as described above with respect to FIGS. 9A and 9B. FIG. 14A shows the end-to-end efficiencies of red light of the disparity test light from different fields of view, FIG. 14B shows the end-to-end efficiencies of green light of the disparity test light from different fields of view, and FIG. 14C shows the end-to-end efficiencies of blue light of the disparity test light from different fields of view. As shown by FIGS. 14A-14C, the mean end-to-end efficiencies of blue light of the disparity test light that propagates in the waveguide along the primary path may be much lower than those for red light and green light.

FIGS. 14D-14F illustrate examples of end-to-end efficiencies of disparity test light of different colors in a waveguide display that includes one or more disparity gratings having different grating vectors (e.g., waveguide display 1000 or 1200) according to certain embodiments. In the examples illustrated in FIGS. 14D-14F, the red light and green light of the disparity test light may propagate in the waveguide along the primary path only, while the blue light of the disparity test light may propagate in the waveguide along both the primary path and the secondary path, as described above with respect to FIGS. 10A-12B and 13B-13C. FIG. 14D shows the end-to-end efficiencies of red light of the disparity test light from different fields of view, FIG. 14E shows the end-to-end efficiencies of green light of the disparity test light from different fields of view, and FIG. 14F shows the end-to-end efficiencies of blue light of the disparity test light from different fields of view. As shown by FIGS. 14D-14F, the mean end-to-end efficiencies of blue light of the disparity test light that propagates in the waveguide along both the primary path and the secondary path may be comparable to or higher than those for red light and green light, and may be much higher (e.g., >40 times or higher) than that shown in FIG. 14C. Therefore, techniques disclosed herein can drastically improve the end-to-end efficiency of the disparity test light, in particular, the end-to-end efficiency of the disparity test light with shorter wavelengths, such as blue light.

Embodiments of the invention may include or be implemented in conjunction with an artificial reality system. Artificial reality is a form of reality that has been adjusted in some manner before presentation to a user, which may include, for example, a virtual reality (VR), an augmented reality (AR), a mixed reality (MR), a hybrid reality, or some combination and/or derivatives thereof. Artificial reality content may include completely generated content or generated content combined with captured (e.g., real-world) content. The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may also be associated with applications, products, accessories, services, or some combination thereof, that are used to, for example, create content in an artificial reality and/or are otherwise used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

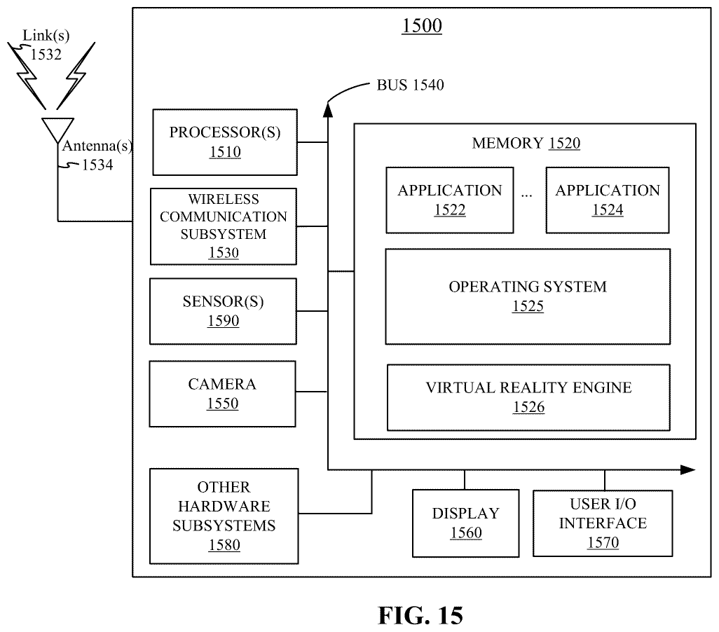

FIG. 15 is a simplified block diagram of an example electronic system 1500 of an example near-eye display (e.g., HMD device) for implementing some of the examples disclosed herein. Electronic system 1500 may be used as the electronic system of an HMD device or other near-eye displays described above. In this example, electronic system 1500 may include one or more processor(s) 1510 and a memory 1520. Processor(s) 1510 may be configured to execute instructions for performing operations at a number of components, and can be, for example, a general-purpose processor or microprocessor suitable for implementation within a portable electronic device. Processor(s) 1510 may be communicatively coupled with a plurality of components within electronic system 1500. To realize this communicative coupling, processor(s) 1510 may communicate with the other illustrated components across a bus 1540. Bus 1540 may be any subsystem adapted to transfer data within electronic system 1500. Bus 1540 may include a plurality of computer buses and additional circuitry to transfer data.

Memory 1520 may be coupled to processor(s) 1510. In some embodiments, memory 1520 may offer both short-term and long-term storage and may be divided into several units. Memory 1520 may be volatile, such as static random access memory (SRAM) and/or dynamic random access memory (DRAM) and/or non-volatile, such as read-only memory (ROM), flash memory, and the like. Furthermore, memory 1520 may include removable storage devices, such as secure digital (SD) cards. Memory 1520 may provide storage of computer-readable instructions, data structures, program code, and other data for electronic system 1500. In some embodiments, memory 1520 may be distributed into different hardware subsystems. A set of instructions and/or code might be stored on memory 1520. The instructions might take the form of executable code that may be executable by electronic system 1500, and/or might take the form of source and/or installable code, which, upon compilation and/or installation on electronic system 1500 (e.g., using any of a variety of generally available compilers, installation programs, compression/decompression utilities, etc.), may take the form of executable code.

In some embodiments, memory 1520 may store a plurality of applications 1522 through 1524, which may include any number of applications. Examples of applications may include gaming applications, conferencing applications, video playback applications, or other suitable applications. The applications may include a depth sensing function or eye tracking function. Applications 1522-1524 may include particular instructions to be executed by processor(s) 1510. In some embodiments, certain applications or parts of applications 1522-1524 may be executable by other hardware subsystems 1580. In certain embodiments, memory 1520 may additionally include secure memory, which may include additional security controls to prevent copying or other unauthorized access to secure information.

In some embodiments, memory 1520 may include an operating system 1525 loaded therein. Operating system 1525 may be operable to initiate the execution of the instructions provided by applications 1522-1524 and/or manage other hardware subsystems 1580 as well as interfaces with a wireless communication subsystem 1530 which may include one or more wireless transceivers. Operating system 1525 may be adapted to perform other operations across the components of electronic system 1500 including threading, resource management, data storage control and other similar functionality.

Wireless communication subsystem 1530 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 1500 may include one or more antennas 1534 for wireless communication as part of wireless communication subsystem 1530 or as a separate component coupled to any portion of the system. Depending on desired functionality, wireless communication subsystem 1530 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.15x, or some other types of network. The techniques described herein may also be used for any combination of WWAN, WLAN, and/or WPAN. Wireless communications subsystem 1530 may permit data to be exchanged with a network, other computer systems, and/or any other devices described herein. Wireless communication subsystem 1530 may include a means for transmitting or receiving data, such as identifiers of HMD devices, position data, a geographic map, a heat map, photos, or videos, using antenna(s) 1534 and wireless link(s) 1532.

Embodiments of electronic system 1500 may also include one or more sensors 1590. Sensor(s) 1590 may include, for example, an image sensor, an accelerometer, a pressure sensor, a temperature sensor, a proximity sensor, a magnetometer, a gyroscope, an inertial sensor (e.g., a subsystem that combines an accelerometer and a gyroscope), an ambient light sensor, or any other similar devices or subsystems operable to provide sensory output and/or receive sensory input, such as a depth sensor or a position sensor. For example, in some implementations, sensor(s) 1590 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 1500 may include a display 1560. Display 1560 may be a near-eye display, and may graphically present information, such as images, videos, and various instructions, from electronic system 1500 to a user. Such information may be derived from one or more applications 1522-1524, virtual reality engine 1526, one or more other hardware subsystems 1580, a combination thereof, or any other suitable means for resolving graphical content for the user (e.g., by operating system 1525). Display 1560 may use liquid crystal display (LCD) technology, light-emitting diode (LED) technology (including, for example, OLED, ILED, μLED, AMOLED, TOLED, etc.), light emitting polymer display (LPD) technology, or some other display technology.

Electronic system 1500 may include a user input/output interface 1570. User input/output interface 1570 may allow a user to send action requests to electronic system 1500. An action request may be a request to perform a particular action. For example, an action request may be to start or end an application or to perform a particular action within the application. User input/output interface 1570 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 1500. In some embodiments, user input/output interface 1570 may provide haptic feedback to the user in accordance with instructions received from electronic system 1500. For example, the haptic feedback may be provided when an action request is received or has been performed.

Electronic system 1500 may include a camera 1550 that may be used to take photos or videos of a user, for example, for tracking the user's eye position. Camera 1550 may also be used to take photos or videos of the environment, for example, for VR, AR, or MR applications. Camera 1550 may include, for example, a complementary metal-oxide-semiconductor (CMOS) image sensor with a few millions or tens of millions of pixels. In some implementations, camera 1550 may include two or more cameras that may be used to capture 3-D images.

In some embodiments, electronic system 1500 may include a plurality of other hardware subsystems 1580. Each of other hardware subsystems 1580 may be a physical subsystem within electronic system 1500. While each of other hardware subsystems 1580 may be permanently configured as a structure, some of other hardware subsystems 1580 may be temporarily configured to perform specific functions or temporarily activated. Examples of other hardware subsystems 1580 may include, for example, an audio output and/or input interface (e.g., a microphone or speaker), a near field communication (NFC) device, a rechargeable battery, a battery management system, a wired/wireless battery charging system, etc. In some embodiments, one or more functions of other hardware subsystems 1580 may be implemented in software.

In some embodiments, memory 1520 of electronic system 1500 may also store a virtual reality engine 1526. Virtual reality engine 1526 may execute applications within electronic system 1500 and receive position information, acceleration information, velocity information, predicted future positions, or some combination thereof of the HMD device from the various sensors. In some embodiments, the information received by virtual reality engine 1526 may be used for producing a signal (e.g., display instructions) to display 1560. For example, if the received information indicates that the user has looked to the left, virtual reality engine 1526 may generate content for the HMD device that mirrors the user's movement in a virtual environment. Additionally, virtual reality engine 1526 may perform an action within an application in response to an action request received from user input/output interface 1570 and provide feedback to the user. The provided feedback may be visual, audible, or haptic feedback. In some implementations, processor(s) 1510 may include one or more GPUs that may execute virtual reality engine 1526.

In various implementations, the above-described hardware and subsystems may be implemented on a single device or on multiple devices that can communicate with one another using wired or wireless connections. For example, in some implementations, some components or subsystems, such as GPUs, virtual reality engine 1526, and applications (e.g., tracking application), may be implemented on a console separate from the head-mounted display device. In some implementations, one console may be connected to or support more than one HMD.

In alternative configurations, different and/or additional components may be included in electronic system 1500. Similarly, functionality of one or more of the components can be distributed among the components in a manner different from the manner described above. For example, in some embodiments, electronic system 1500 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium,” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean A, B, C, or a combination of A, B, and/or C, such as AB, AC, BC, AA, ABC, AAB, ACC, AABBCCC, or the like.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components, or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A waveguide display system comprising:
a waveguide;
an input coupler configured to couple disparity test light into the waveguide;
a first disparity grating on a peripheral region of the waveguide;
a second disparity grating on the peripheral region of the waveguide; and
one or more output gratings on the waveguide and configured to:
direct a first portion of the disparity test light coupled into the waveguide along a first path to the first disparity grating; and
direct a second portion of the disparity test light coupled into the waveguide along a second path to the second disparity grating,
wherein the first disparity grating is configured to couple the first portion of the disparity test light out of the waveguide; and
wherein the second disparity grating is configured to couple the second portion of the disparity test light out of the waveguide.

2. The waveguide display system of claim 1, wherein the second portion of the disparity test light includes a portion of blue light of the disparity test light.

3. The waveguide display system of claim 1, wherein the second portion of the disparity test light has a larger incident angle at surfaces of the waveguide than the first portion of the disparity test light.

4. The waveguide display system of claim 1, wherein the first disparity grating and the second disparity grating are characterized by different grating vectors, and are on opposing surfaces of the waveguide or different regions of a surface of the waveguide.

5. The waveguide display system of claim 1, wherein the first disparity grating and the second disparity grating are characterized by different grating vectors, and are on a same region or overlapped regions of a surface of the waveguide to form a two-dimensional grating.

6. The waveguide display system of claim 1, wherein the first disparity grating and the second disparity grating include surface-relief gratings.

7. The waveguide display system of claim 1, wherein the one or more output gratings include a first output grating and a second output grating, wherein:
the first output grating is configured to direct the first portion of the disparity test light to the second output grating; and
the second output grating is configured to:
direct the first portion of the disparity test light to the first disparity grating; and
direction the second portion of the disparity test light to the second disparity grating.

8. The waveguide display system of claim 7, wherein the first output grating and the second output grating include surface-relief gratings and are on opposing surfaces of the 2 waveguide.

9. The waveguide display system of claim 1, wherein:
the input coupler is further configured to couple display light into the waveguide; and
the one or more output gratings are configured to replicate the display light in one or two dimensions.

10. The waveguide display system of claim 1, further comprising a disparity sensor configured to receive the first portion of the disparity test light and the second portion of the 2 disparity test light.

11. The waveguide display system of claim 10, further comprising a second waveguide or a reflector assembly configured to deliver the first portion of the disparity test light and the second portion of the disparity test light to the disparity sensor.

12. The waveguide display system of claim 10, further comprising:
a projector configured to generate the disparity test light; and
a controller configured to control the projector based on outputs of the disparity sensor.

13. The waveguide display system of claim 1, wherein the input coupler includes three input gratings, each input grating of the three input gratings configured to couple the disparity test light of a respective color into the waveguide.

14. A near-eye display system comprising:
a waveguide transparent to visible light;
a projector configured to project disparity test light onto the waveguide;
an input coupler configured to couple the disparity test light into the waveguide; and
a set of gratings on the waveguide and configured to: guide the disparity test light to propagate along two different paths in the waveguide; and
couple the disparity test light propagating along the two different paths out of the waveguide at a peripheral region of the waveguide.

15. The near-eye display system of claim 14, wherein:
the set of gratings includes two disparity gratings, each disparity grating of the two disparity gratings configured to couple the disparity test light propagating along a respective path of the two different paths out of the waveguide; and
the two disparity gratings are characterized by different grating vectors, and are on opposing surfaces of the waveguide or different regions of a surface of the waveguide.

16. The near-eye display system of claim 14, wherein the set of gratings includes a two-dimensional disparity grating characterized by two different grating vectors.

17. The near-eye display system of claim 14, wherein:
the disparity test light propagating along a first path of the two different paths includes only blue light; and
the disparity test light propagating along the first path of the two different paths has a larger incident angle at surfaces of the waveguide than the disparity test light propagating along a second path of the two different paths.

18. The near-eye display system of claim 14, wherein the set of gratings includes a first output grating, a second output grating, a first disparity grating, and a second disparity grating, wherein:
the first output grating is configured to direct a first portion of the disparity test light to the second output grating along a first path of the two different paths; and
the second output grating is configured to:
direct the first portion of the disparity test light along the first path of the two different paths to the first disparity grating; and
direction a second portion of the disparity test light along a second path of the two different paths to the second disparity grating.

19. The near-eye display system of claim 14, wherein:
the input coupler is further configured to couple display light into the waveguide; and
the set of gratings is configured to replicate the display light in one or two dimensions.

20. The near-eye display system of claim 14, further comprising:
a disparity sensor;
an optical assembly configured to deliver the disparity test light propagating along the two different paths to the disparity sensor; and
a controller configured to control the projector based on outputs of the disparity sensor.
